(19) United States
(12) Patent Application Publication
(10) Pub. No.: US 2023/0061195 A1
(43) Pub. Date: Mar. 2, 2023

(54) ENHANCED TRANSPARENT TRAILER

(71) Applicant: Continental Automotive Systems, Inc., Auburn Hills, MI (US)

(72) Inventors: Boyd Quinton, Waterford, MI (US); Aranza Hinojosa Castro, Ferndale, MI (US)

(73) Assignee: Continental Automotive Systems, Inc., Auburn Hills, MI (US)

(21) Appl. No.: 17/446,281

(22) Filed: Aug. 27, 2021

(51) Int. Cl. B60R 1/00; B60R 11/04; G06F 16/50

(52) U.S. Cl. CPC B60R 1/00; B60R 11/04; G06F 16/50; B60R 2011/004

(57) ABSTRACT

A system for generating a composite image of an area behind a vehicle includes a controller that receives a first image of a trailer from a vehicle camera and a second image of an area aft of the trailer with a trailer camera. A portion of the area around the vehicle is not within a line of sight of either the vehicle camera or the trailer camera. A third image of an area proximate the vehicle is obtained from a database containing previously obtained images and combines the first image, the second image and the third image into a composite image. A method of generating a composite image is also disclosed.

### TECHNICAL FIELD

The present disclosure relates to a system and method for viewing an environment behind a vehicle and trailer.

### BACKGROUND

A rear facing camera is used to aid a driver in reversing a vehicle. A trailer attached to the vehicle may also include a camera to provide the driver with images of the environment behind the trailer. Combining images from the vehicle and the trailer can provide a view that appears to the vehicle operator as if they are looking through the trailer. Such a view is commonly referred to as a transparent trailer view. The transparent trailer view is formed from a combination of images and can provide a useful view to a vehicle operator. However, the various camera angles and resulting images often do not capture all areas proximate the vehicle. Image manipulation is then used to fill in those missing areas. Such image manipulation can result in discontinuities that distract a driver and detract from the usefulness of a transparent trailer view.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system for generating a composite image of an area behind a vehicle according to a disclosed example embodiment includes, among other possible things, a controller configured to receive a first image of a trailer from a vehicle camera, receive a second image of an area aft of the trailer with a trailer camera, obtain a third image of an area proximate the vehicle from a database containing previously obtained images and combine the first image, the second image and the third image into a composite image.

In another disclosed embodiment of the foregoing system for generating a composite image of an area behind a vehicle, the third image comprises a view of a portion of the environment obstructed by the trailer.

In another disclosed embodiment of any of the foregoing systems for generating a composite image of an area behind a vehicle, the third image is combined with the first image and the second image and corresponds with an area obstructed from view of the vehicle camera by the trailer.

In another disclosed embodiment of any of the foregoing systems for generating a composite image of an area behind a vehicle, the third image is combined with the first image and the second image and corresponds with a perspective discontinuity between the first image and the second image.

In another disclosed embodiment of any of the foregoing systems for generating a composite image of an area behind a vehicle, the controller is configured to combine the second image of an area aft of the trailer and at least a portion of the first image including the trailer.

In another disclosed embodiment of any of the foregoing systems for generating a composite image of an area behind a vehicle, the controller is configured to combine the third image to occupy an area of the front face of the trailer corresponding to a region unseen by the vehicle camera with the first image and the second image.

In another disclosed embodiment of any of the foregoing systems for generating a composite image of an area behind a vehicle, the controller is configured to receive information indicative of vehicle operation dynamics and combine the first image, the second image and the third image based on the received information indicative of vehicle operation dynamics.

In another disclosed embodiment of any of the foregoing systems for generating a composite image of an area behind a vehicle, the vehicle operation dynamics includes a relative orientation between the vehicle and the trailer and the controller is configured to form the composite image based on the relative orientation between the vehicle and the trailer.

In another disclosed embodiment of any of the foregoing systems for generating a composite image of an area behind a vehicle, obtaining the third image from the database is based at least in part on the relative orientation between the vehicle and trailer.

A method of forming a composite image of an area behind a vehicle towing a trailer according to another disclosed example embodiment includes, among other possible things, capturing a first image of an area behind a tow vehicle, capturing a second image of an area behind a trailer, obtaining a third image of an area proximate the tow vehicle from a database, and combining the first image, the second image and the third image into a composite image.

In another disclosed embodiment of the foregoing method, combining the first image, the second image and the third image comprises combining a portion of the third image with the first image and the second image to correspond with a perspective discontinuity between the first image and the second image.

Another disclosed embodiment of any of the foregoing methods further comprises combining the second image over at least a portion of the first image including the trailer.

Another disclosed embodiment of any of the foregoing methods further comprises combining the third image with the first image in a portion of the first image that is blocked from view by the trailer.

Another disclosed embodiment of any of the foregoing methods, further comprising obtaining information indicative of vehicle operation dynamics and combining the first image, the second image and the third image based on the received information indicative of vehicle operation dynamics.

In another disclosed embodiment of any of the foregoing methods, the vehicle operation dynamics includes a relative orientation between the vehicle and the trailer and forming the composite image is performed based on the relative orientation between the vehicle and trailer.

Another disclosed embodiment of any of the foregoing methods, further comprising obtaining the third image from the database based in part on the relative orientation between the vehicle and trailer.

A non-transitory computer readable medium including instructions executable by at least one processor according to another example disclosed embodiment includes, among other possible things, instructions executed by the at least one processor that prompt capture of a first image of an area behind a tow vehicle, instructions executed by the at least one processor that prompt capture of a second image of an area behind a trailer, instructions executed by the at least one processor to obtain a third image of an area surrounding the vehicle from a database, and instructions that prompt combining the first image, the second image and the third image into a composite image.

In another disclosed embodiment of the foregoing non-transitory computer readable medium, the instructions for combining the first image, the second image and the third image comprises instructions that govern combining the third image with the first image and the second image to correspond with a perspective discontinuity between the first image and the second image.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of vehicle and trailer including an example system for generating a composite image of an area behind the vehicle.

FIG. 2 is a schematic view of an orientation between the vehicle and the trailer.

FIG. 3 is a schematic view of images that are combined to generate the composite image.

FIG. 4 is a schematic view of an example composite image.

### DETAILED DESCRIPTION

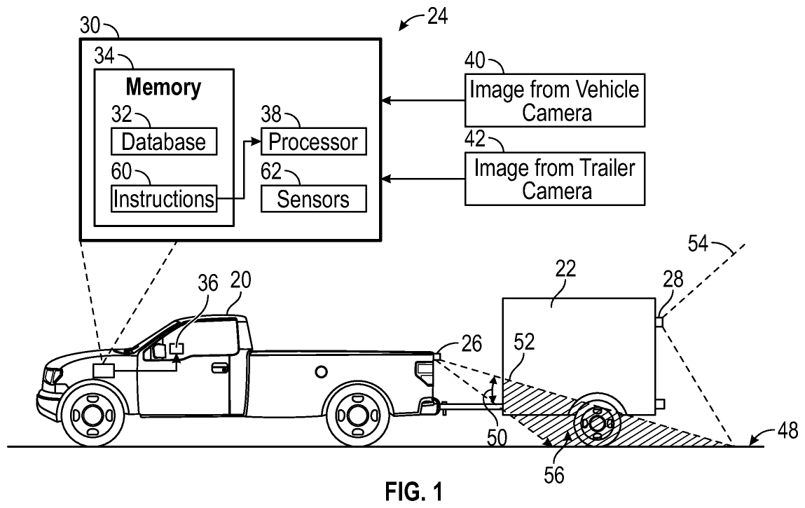

Referring to FIG. 1, a vehicle 20 and trailer 22 are schematically shown and includes a system 24 for generating a composite image of an area behind the vehicle 20. An image from a vehicle camera 26 is combined with an image from a trailer camera 28 and historical images stored in a database 32 to generate a composite image viewable on a display 36 to a vehicle operator. The composite image makes the trailer 22 appear transparent to provide an unobstructed view of the area behind the vehicle.

The system 24 uses a first image 40 from the vehicle camera 26 of the trailer 22 and surrounding environment with a second image 42 from the trailer camera 28 to form an image that appears to be looking through the trailer 22. The trailer camera 28 provides a field of view indicated by dashed lines 54. A region 56 is obstructed from view of the vehicle camera 26 by the trailer 22 and is also outside the field of view 54 of the trailer camera 28. Accordingly, region 56 represents an area unseen by any camera.

The unseen region 56 causes an undesirable visual discontinuity that manifests in the composite image as an area of the trailer face for which the appropriate line of sight is either unavailable or not accurately represented. The resulting image is therefore not “fully-transparent” and results in a distorted final image. An unrepresented region 50 is defined in this example embodiment as the region of the trailer face below projection line 52 linking the vehicle camera's aperture to the point of intersection between the field of view of the trailer camera 28 and the roadway 48.

The disclosed example system 24 uses a stored image from a database 32 to continuously populate the unrepresented region 50 resulting from the unseen region 56. The resulting composite image is better matched with less visible discontinuity. It should be appreciated, that although the unrepresented region 50 resulting from unseen region 56 is addressed in this example embodiment, other portions of the trailer, or the environment surrounding the vehicle 20 that are unseen by a system camera could also benefit from the system and method of this disclosure to provide a composite image.

The example disclosed system 24 includes the controller 30 that includes a memory module 34 and a processor 38. The memory module 34 includes the database 32 with historic images that are combined into the composite image.

The memory module 34 also provides a non-transitory computer readable medium for storage of processor executable software instructions. The instructions direct the processor to capture the first image, the second image and a third image from the database 32 into the composite image. The instructions prompt operation to correct a perspective discontinuity between the first image and the second image with the added third image.

The example disclosed processor 38 may be a hardware device for executing software, particularly software stored in memory. The processor 38 can be a custom made or commercially available processor, a central processing unit (CPU), an auxiliary processor among several processors associated with the computing device, a semiconductor-based microprocessor (in the form of a microchip or chip set) or generally any device for executing software instructions.

The memory 34 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 34 may incorporate electronic, magnetic, optical, and/or other types of storage media. Note that the memory can also have a distributed architecture, where various components are situated remotely from one another, but can be accessed by the processor.

The software instructions 60 in the memory 34 may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

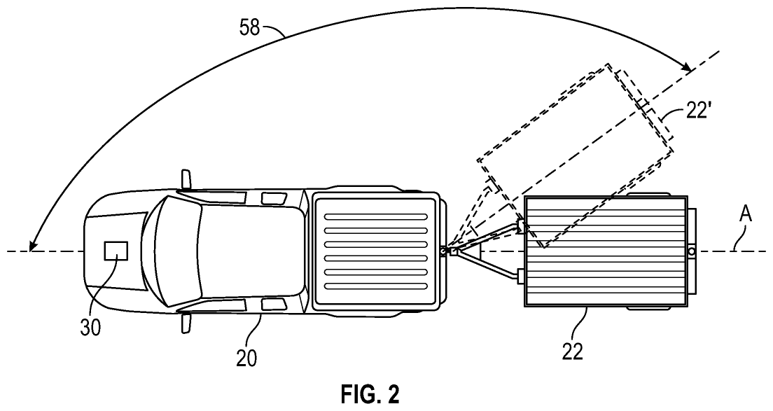

Referring to FIG. 2, with continued reference to FIG. 1, the vehicle 20 includes sensors 62 that provide information indicative of vehicle dynamics and relative orientation between the trailer 22 and the vehicle 20. As is schematically shown, the sensors 62 are utilized to determine a relative orientation between the vehicle 20 and trailer 22. That orientation is utilized to select an image from the database 32 for the composite image. Moreover, the orientation may also be utilized to determine the method and region for combining available images into the composite image 46.

For example, the sensors 62 may provide an indication of an angle 58 of the trailer 22 relative to the vehicle 20. When the trailer 22 is directly behind the vehicle 20 along the axis A, one set of images and/or combination method may be appropriate. When the trailer is disposed at the angle 58 relative to the vehicle as indicated at 22′, another set of images and/or combination method may be appropriate for that orientation and may be utilized and combined with the images from the vehicle camera 26 and the trailer camera 28.

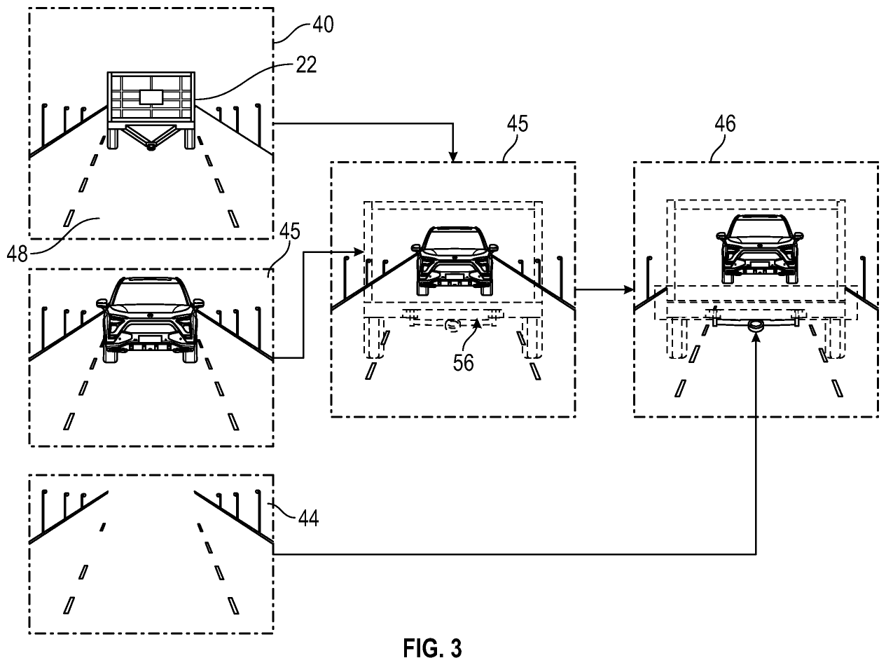

Referring to FIG. 3, with continued reference to FIGS. 1 and 2, a composite image 46 is formed by stitching the first image 40 with the second image 42 as an intermediate image 45. The intermediate image 45 is then further combined with a third image 44 obtained from a historical database 32 of images. The third image 44 is a view of the environment not seen by vehicle camera 26. In this example, the third image 44 is a view of a portion of the road 48 that is obstructed by the trailer 22. This view of the road 48 is in the region 56 (FIG. 1) that is not within view of any system camera. Accordingly, the third image 44 replaces the portions in the composite image that would otherwise be absent and/or distorted.

The size and shape of the portions of the second image 42 that are stitched into the first image 40 correspond with an outline of the trailer 22. The size and shape of the portions of the third image 44 that are stitched into the intermediate image 45 correspond with the unseen region 56 that corresponds to the area 50. The processor 38 may be utilized to execute image processing algorithms to determine the size and shape of the distorted area and stitch the third image 44 into the composite image based on that determination. The size and shape of the third image 44 that is stitched into the composite image may be selected from a group of sizes and shapes that correspond with different vehicle operations. Moreover, other methods and criteria for determining the size and shape of the portion of the third image 44 stitched into the composite image 46 could be utilized and are within the scope and contemplation of this disclosure. Additionally, although the example composite image is formed utilizing one stored historic image, additional images could be incorporated to form the composite image and are within the scope and contemplation of this disclosure. A fourth, fifth and/or any number of images could be combined to address unseen portions and provide a desired composite image.

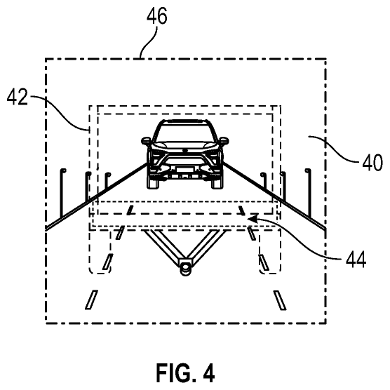

Referring to FIG. 4, with continued reference to FIGS. 1 and 3, the composite image 46 provides a transparent trailer view that accommodates for unviewable regions with historic or alternate camera data rather than distortion of the available images. Rather than stretch available images in a manner that may cause noticeable distortions, the saved alternate images are combined to provide a better and more natural appearance for the composite image 46. The second image 42 is not stretched to cover the unseen portions. Instead, all or portions of the third image 44 is added to the unseen portions. The composite image 46 includes the first image 40 from the vehicle camera 26 combined with the second image from the trailer camera 28. The second image 42 is stitched into the outline of the trailer 22 in the first image 40. The third image 44 is stitched into the first image 40 within an area of the outline of the trailer 22 to provide a visually consistent, non-distorted image.

The third image 44 is selected from historical image data that can be stored in the database 32. In one disclosed embodiment, the historical images can be previous images taken by the vehicle camera 26. However, other available sources for historical images suitable for combination to form the composite image could be utilized and are within the contemplation and scope of this disclosure.

Accordingly, the example system utilizes at least one additional image to reduce perceived discontinuities that may detract from the composite image viewed by a vehicle operator. The additional image is obtained from a historical database rather than from a camera and therefore does not require additional structure or hardware.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A system for generating a composite image of an area behind a vehicle, the system comprising:
a controller configured to:
receive a first image of a trailer from a vehicle camera;
receive a second image of an area aft of the trailer with a trailer camera;
obtain a third image of an area proximate the vehicle from a database containing previously obtained images; and
combine the first image, the second image and the third image into a composite image.

2. The system as recited in claim 1, wherein the third image comprises a view of a portion of the environment obstructed by the trailer.

3. The system as recited in claim 1, wherein the third image is combined with the first image and the second image and corresponds with an area obstructed from view of the vehicle camera by the trailer.

4. The system as recited in claim 1, wherein the third image is combined with the first image and the second image and corresponds with a perspective discontinuity between the first image and the second image.

5. The system as recited in claim 2, wherein the controller is configured to combine the second image of an area aft of the trailer and at least a portion of the first image including the trailer.

6. The system as recited in claim 5, wherein the controller is configured to combine the third image to occupy an area of a front face of the trailer corresponding to a region unseen by the vehicle camera with the first image and the second image.

7. The system as recited in claim 1, wherein the controller is configured to receive information indicative of vehicle operation dynamics and combine the first image, the second image and the third image based on the received information indicative of vehicle operation dynamics.

8. The system as recited in claim 7, wherein the vehicle operation dynamics includes a relative orientation between the vehicle and the trailer and the controller is configured to form the composite image based on the relative orientation between the vehicle and the trailer.

9. The system as recited in claim 8, wherein obtaining the third image from the database is based at least in part on the relative orientation between the vehicle and trailer.

10. A method of forming a composite image of an area behind a vehicle towing a trailer, the method comprising:
capturing a first image of an area behind a tow vehicle;
capturing a second image of an area behind a trailer;
obtaining a third image of an area proximate the tow vehicle from a database; and
combining the first image, the second image and the third image into a composite image.

11. The method as recited in claim 10, wherein combining the first image, the second image and the third image comprises combining a portion of the third image with the first image and the second image to correspond with a perspective discontinuity between the first image and the second image.

12. The method as recited in claim 10, comprising combining the second image over at least a portion of the first image including the trailer.

13. The method as recited in claim 10, comprising combining the third image with the first image in a portion of the first image that would be seen if not blocked from view by the trailer.

14. The method as recited in claim 10, comprising obtaining information indicative of vehicle operation dynamics and combining the first image, the second image and the third image based on the received information indicative of vehicle operation dynamics.

15. The method as recited in claim 14, wherein the vehicle operation dynamics includes a relative orientation between the vehicle and the trailer and forming the composite image is performed based on the relative orientation between the vehicle and trailer.

16. The method as recited in claim 10, including obtaining the third image from the database based in part on the relative orientation between the vehicle and trailer.

17. A non-transitory computer readable medium including instructions executable by at least one processor, the instructions comprising:
instructions executed by the at least one processor that prompt capture of a first image of an area behind a tow vehicle;
instructions executed by the at least one processor that prompt capture of a second image of an area behind a trailer;
instructions executed by the at least one processor to obtain a third image of an area surrounding the vehicle from a database; and
instructions that prompt combining the first image, the second image and the third image into a composite image.

18. The non-transitory computer readable medium as recited in claim 17, wherein the instructions for combining the first image, the second image and the third image comprises instructions that govern combining the third image with the first image and the second image to correspond with a perspective discontinuity between the first image and the second image.
